(19) United States
(12) Patent Application Publication
(10) Pub. No.: US 2026/0253467 A1
(43) Pub. Date: Aug. 27, 2026

(54) SYSTEMS AND METHODS FOR SELECTIVE ENGAGEMENT WITH READERS IN MULTI-READER ENVIRONMENT

(71) Applicant: ASSA ABLOY AB, Stockholm (SE)

(72) Inventors: Almir Zupcic, Stockholm (SE); Ronny Belin, Sollentuna (SE); Sivarajan Manoharan, Chennai (IN); Gopinath Krishnan, Vaniyambadi (IN); Jeyamuruga Ganesan, Chennai (IN); Steve Belt, Hutto, TX (US)

(21) Appl. No.: 19/489,719

(22) PCT Filed: Apr. 25, 2024
(86) PCT No.: PCT/US2024/026138

§ 371 Date: Dec. 3, 2025

(30) Foreign Application Priority Data
Jun. 6, 2023 (IN) 202311038691

(51) Int. Cl. G07C 9/00; G07C 9/20

(52) U.S. Cl. CPC G07C 9/00309; G07C 9/20; G07C 2209/63

(57) ABSTRACT

Systems and techniques may be used for selective engagement with a secure reader, for example in a multi-reader environment. An example technique may include detecting one or more secure access readers of a secure access system that are proximate to a mobile device, and identifying a list of predetermined secure access readers. The detected one or more secure access readers proximate to the mobile device may be compared to the list of predetermined secure access readers to identify a listed proximate secure access reader. The example technique may include, in response to identifying the listed proximate secure access reader, engaging, via the mobile device, with the listed proximate secure access reader.

### CLAIM OF PRIORITY

This application claims the benefit of priority to India Provisional Application No. 202311038691 filed Jun. 6, 2023, titled “SYSTEMS AND METHODS FOR SELECTIVE ENGAGEMENT WITH READERS IN MULTI-READER ENVIRONMENT,” which is hereby incorporated herein by reference in its entirety.

### TECHNICAL FIELD

Among other technical fields, embodiments of the present disclosure pertain to access control systems (including physical, electronic, logical, etc. access control systems), wireless communication (e.g., Bluetooth), and, more particularly, to systems and methods for selective engagement with readers in a multi-reader environment.

### BACKGROUND

Security is an ever-increasing concern in today's world. This concern extends to, among other areas of life, security related to protecting physical spaces such as homes, offices, labs, engineering facilities, hospitals, and so forth. In a typical arrangement, and using a particular floor of an office building as an example physical space, that floor (or the office building generally, particular rooms, elevator banks, and the like therein) may be protected by what is known in the art as a physical access control system (PACS) or electronic access control system (EACS), among other possibilities.

In an example situation, one or more elevators to the particular floor may open into a small lobby that includes a secure door that, when closed and locked, prevents physical access to the rest of the floor. A locking mechanism for that door may be controlled by a device known as a reader. This reader may be operable to respond to one or more types of wireless communication from one or more devices such as radio frequency (RF) tags, fobs, keycards, mobile devices (e.g., Bluetooth or Bluetooth Low Energy (BLE)), or the like. BLE is a wireless personal area network (PAN) technology that, as compared with conventional Bluetooth, is designed to provide significantly lower power consumption.

In some cases, a reader may also have a keypad that may be used to key in a valid credential (e.g., a correct passcode). As a general matter, upon receipt from a given device (or its own keypad in some cases) of a valid credential, the reader may unlock the door to permit access to the rest of the floor. In a typical case, the door may then automatically close and lock on its own. A given valid credential may take a number of different forms and include one or more encrypted or unencrypted data values. More generally, it is noted that, in the present disclosure, the term “credential” is used broadly to encompass any set of one or more (encrypted or unencrypted) values that are provided for access to-or activation of, etc.-a given resource, be it a physical space as in the aforementioned example of a floor of an office building, an electronic resource (e.g., a given computing terminal, a given network server, a given online account (e.g., bank account), or the like), or one or more other protected resources.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example security arrangement, in accordance with at least one embodiment.

FIG. 2 depicts an example office floorplan, in accordance with at least one embodiment.

FIG. 3 depicts a first example user interface, in accordance with at least one embodiment.

FIG. 4 depicts a second example user interface, in accordance with at least one embodiment.

FIG. 5 depicts a third example user interface, in accordance with at least one embodiment.

FIG. 6 depicts a fourth example user interface, in accordance with at least one embodiment.

FIG. 7 depicts a fifth example user interface, in accordance with at least one embodiment.

FIG. 8 depicts a sixth example user interface, in accordance with at least one embodiment.

FIG. 9 depicts an example computer system that may be configured to perform at least one embodiment or embody one or more devices, systems, or the like in accordance with at least one embodiment.

FIG. 10 depicts an example software architecture that may be implemented on a computer system such as the example computer system of FIG. 9, in accordance with at least one embodiment.

FIG. 11 depicts a flowchart showing a technique for selective engagement with a secure reader, in accordance with at least one embodiment.

### DETAILED DESCRIPTION

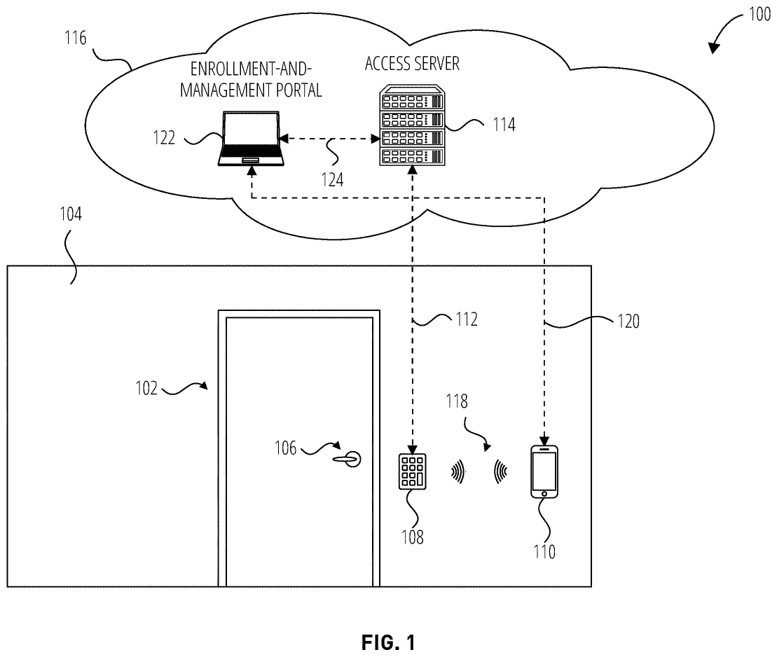

FIG. 1 shows an example security arrangement 100 that may be used in connection with at least some embodiments of the present disclosure. As a general matter, the examples that are provided in the present disclosure largely involve using a smartphone to gain access to a physical resource such as a floor of a building. It should be understood, however, that this is purely for clarity of presentation and by way of example. One or more of the various embodiments that are described herein may be applied to other contexts, in connection with access to (or activation of, etc.) one or more different physical or electronic (e.g., computing) resources, logical resources, or the like. As examples, one or more embodiments of the present disclosure may be applied to an EACS, a logical access control system (LACS), or the like. Different types of wireless communication may be used in different implementations. Additional or different arrangements may occur to those of skill in the art having the benefit of the present disclosure.

As may be seen in FIG. 1, in the example security arrangement 100, a door 102 is disposed on a wall 104, behind which may be a protected resource. In the present example, that protected resource is most of the floor of a given building (e.g., other than an elevator lobby). The door 102 has disposed thereon a handle 106, which in this example is equipped with a locking mechanism (not explicitly depicted) that is controlled by a reader 108 (e.g., a secure access reader). In the depicted scenario, the reader 108 is positioned proximate the door 102, and in particular is positioned proximate the handle 106 of the door 102. The handle 106 may have at least a locked state and an unlocked state.

In an example scenario, the handle 106 is in the locked state in its default mode of operation, and the reader 108 is operable to selectively place the handle 106 in the unlocked state responsive to being presented with an authorized credential by, e.g., a smartphone in accordance with embodiments of the present disclosure. As noted above, the reader 108 may also work with other types of secure devices, keypad entry, or the like. In the example that is depicted in FIG. 1, a smartphone 110 is shown as being in wireless communication with the reader 108. In the depicted embodiment, the smartphone 110 is associated with an authorized user having a credential to enable the unlocking of the handle 106. Moreover, in the depicted example, wireless communication 118 between the smartphone 110 and the reader 108 utilizes BLE communication, though one or more other types of wireless communication may be used as well, such as RF, Near Field Communication (NFC), or the like. NFC, which typically utilizes a 13.56 MHz air interface, is a short-range wireless-connectivity standard that enables communication between devices when they are touched together, or brought within a few centimeters of each other.

In some arrangements, the reader 108 itself may locally determine whether or not to grant access. In other arrangements, the reader 108 may consult an access server 114 (or other entity, device, system, etc.) via a communication link 112 in making a decision to grant or deny access. The reader 108 may securely provide the credential received from the smartphone 110 to the access server 114. It is noted that the referenced credential often takes the form of or at least includes what is known as a “Mobile ID,” which in at least one embodiment is a virtual credential that is stored on a mobile device such as a smartphone. In an example implementation, Mobile IDs are unique to each such device and may not be copied-i.e., if a user switches devices, a new Mobile ID must be issued.

As used in the present disclosure, unless otherwise specified, a given communication link may include one or more wired-communication links or one or more wireless-communication links, as deemed suitable by those of skill in the art for a given implementation or in a given context. The access server 114 may include one or more devices, and may be part of (or resident in, etc.) a cloud system 116, as an example. In some instances, an onsite controller may be queried by the reader 108 as part of determining whether to grant or deny access to a given resource. Other arrangements are possible as well.

Furthermore, it may also be seen in FIG. 1 that the cloud system 116 includes an enrollment-and-management portal 122, which may be used for functions such as onboarding new users, distributing credentials, managing credentials, managing authorized devices, or the like. In some embodiments, the smartphone 110 may communicate over a communication link 120 with the enrollment-and-management portal 122. Moreover, the enrollment-and-management portal 122 and the access server 114 may communicate with one another over a communication link 124. The various dashed-line arrows in FIG. 1 are intended to indicate that the various corresponding devices may communicate with one another, not that they necessarily do. Moreover, there may be one or more communication links not explicitly depicted in FIG. 1.

In connection with a given reader such as the reader 108, a smartphone may be configured to be able to unlock the door 102 based on a trigger action, such as using one or more types of gestures, actions, or the like, each of which is designed to trigger the transmission of a secure credential from the smartphone 110 to the reader 108. In some embodiments, a user may utilize a “tap gesture” according to which the user taps the smartphone 110 to the reader 108 similar to the way another physical credential (e.g., keycard, fob, etc.) may typically be used. If the provided credential is validated, the handle 106 may unlock, and an LED on the reader 108 may briefly change from red to green, among other possibilities. The smartphone 110 may also be configured to vibrate in response to this transaction occurring. This type of short-range communication may use NFC, BLE, RF, or the like.

In some embodiments, the smartphone 110 is configured such that a “twist-&-go gesture” may be utilized to cause the handle 106 to unlock. This may be a type of gesture that may be used even when the smartphone 110 is a longer distance (e.g., about 2 meters (i.e., about 6 feet)) from the reader 108. On approaching the door 102, a user may (by way of example) twist the smartphone 110 briefly 90° to the right and left as if turning a doorknob. As before, if the attempt to unlock the handle 106 is successful, the handle 106 may unlock, and an LED on the reader 108 may briefly change from red to green, the smartphone 110 may vibrate, among other possibilities. This type of longer-range communication may use BLE, among other options.

Moreover, other gestures may be used in addition to or instead of those described here. In cases in which an unlock attempt is unsuccessful, the reader 108 may simply not respond, or may emit a particular sound, display a particular message, or the like.

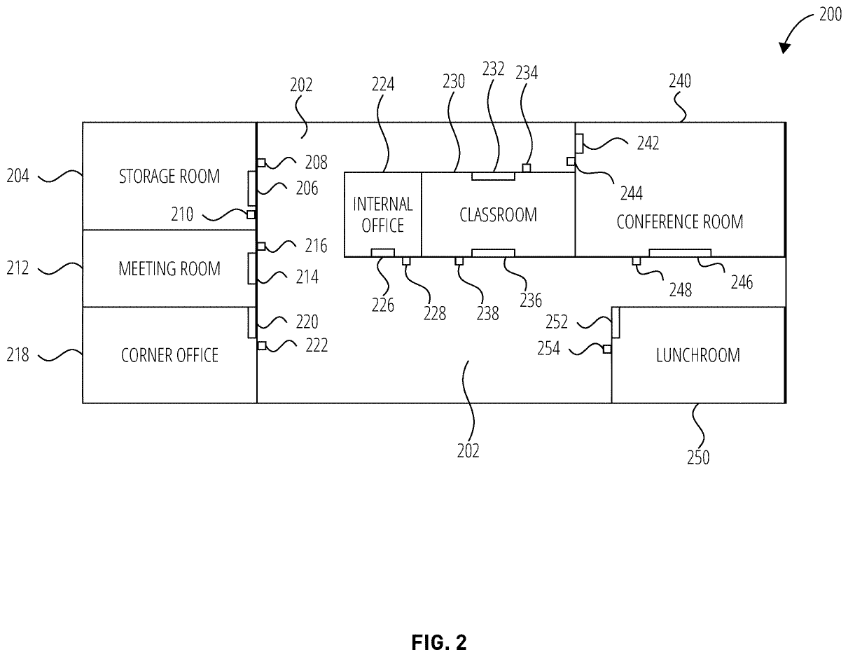

FIG. 2 depicts an example office floorplan 200, in accordance with at least one embodiment. This example office floorplan 200 is provided for illustration, as clearly innumerable other floorplans, arrangements, and the like may be present in a given implementation. The example office floorplan 200 may be an example secure access system. Other secure access systems may include a school, a home, a bank, etc. Multiple locations may be part of a secure access system. A secure access system may include one or more secure access readers that secure one or more resources, which may include physical resources (e.g., a door, a safe, a floor, etc.) or digital resources (e.g., a digital folder, a file, an application, etc.).

As shown in FIG. 2, the office floorplan 200 includes a shared space 202, as well as a storage room 204 having a door 206 that is secured by a both an entry reader 208 and an exit reader 210. This is an example of the fact that, in some cases, a given space or other resource may be protected by both an entry reader and an exit reader. Unless otherwise specified herein, a reader that is referred to as just a “reader” is an entry reader. A given organization may have its reasons for wanting certain spaces protected by both an entry reader and an exit reader. For example, a business may store highly classified materials in the storage room 204, and may have strict requirements for tracking who is in the storage room 204, at what time, and for how long. Certainly other such examples may be described here as well.

Moving on with the office floorplan 200, there is a meeting room 212 that has a door 214 that is secured by a reader 216, a corner office 218 having a door 220 secured by a reader 222, an internal office 224 having a door 226 that is secured by a reader 228, a classroom 230 having a door 232 secured by a reader 234 and also having a door 236 secured by a reader 238, a conference room 240 having a door 242 that is secured by a reader 244 and also having a door 246 that is secured by a reader 248, and finally a lunchroom 250 having a door 252 that is secured by a reader 254.

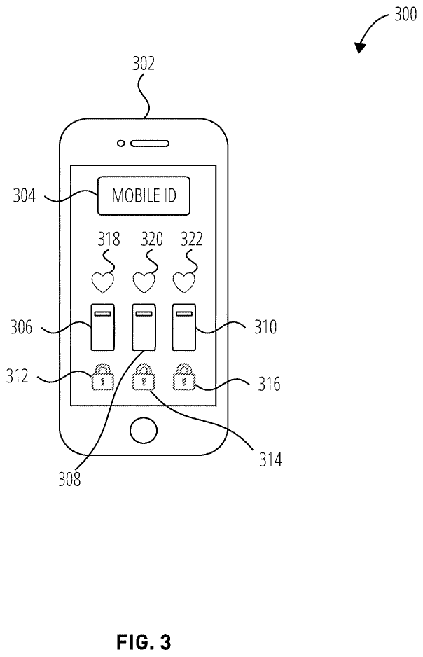

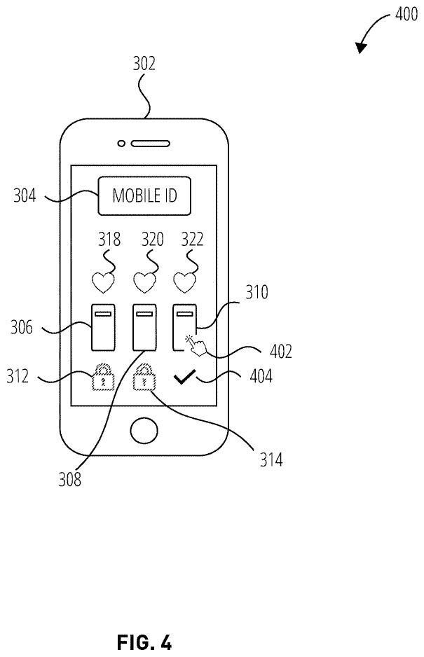

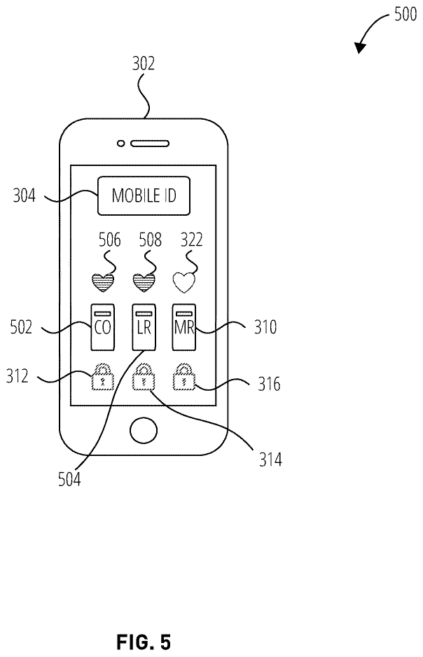

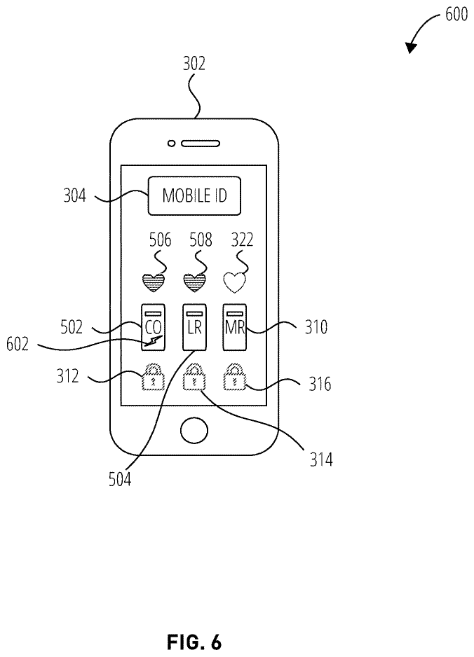

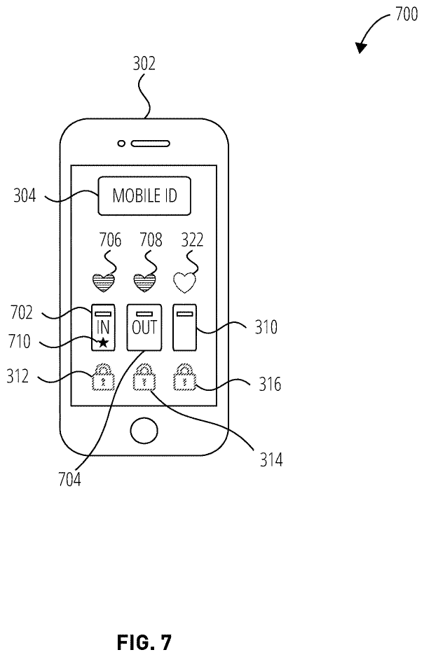

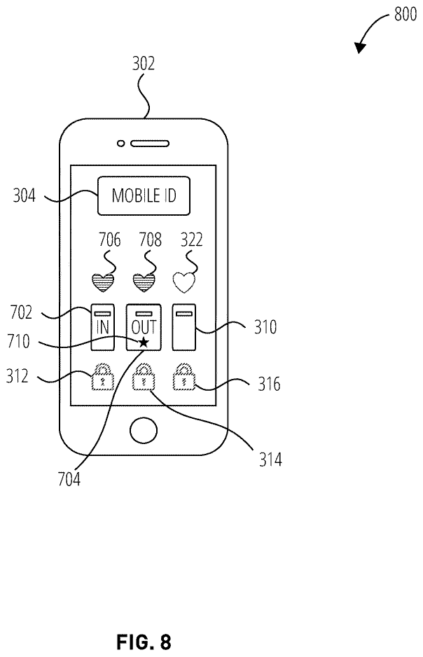

The various elements that are depicted in and described in connection with FIG. 2 are used for illustration of various embodiments in the ensuing descriptions of FIG. 3, FIG. 4, FIG. 5, FIG. 6, FIG. 7, and FIG. 8. Each of those six figures depicts an example user interface of an example smartphone. That smartphone may be running an app that enables the smartphone to be used in the manner described as a token of access to various portions of the herein-described office floorplan 200. It may also certainly be the case that certain rooms (e.g., the lunchroom 250) may not be protected by a reader. Moreover, it is noted that the various icons and other user interface elements, as well as the depicted arrangement of those elements, are provided purely by example and not by way of limitation. Other types, shapes, etc. of icons or other user-interface elements may certainly be used, as may any number of other arrangements of such icons or other user-interface elements.

FIG. 3 depicts a first example user interface 300, in accordance with at least one embodiment. The example user interface 300 depicts an embodiment in which a user may designate certain ones of the readers shown in FIG. 2 as being “favorite” readers. Example functionality associated with that designation is described below. In accordance with at least some such embodiments, a user of a smartphone 302 may, in an associated app, designate one or more readers as being their favorite readers. In some embodiments, a mobile credential (e.g., the depicted mobile ID 304) is only sent to a user's designated favorite reader even though the smartphone 302 may be in the read range of several readers.

Consider an example in which only a single reader-the reader 216 associated with the meeting room 212—in the office floorplan 200 is designated as a favorite by a user of the smartphone 302. Once in range, the user may then be able to use a gesture such as the above-described twist-&-go gesture to unlock the door 214 of the meeting room 212 without also (or instead) engaging one or more other readers such as the entry reader 208, the reader 222, or the like. Thus, the designation of the reader 216 as a favorite is a signal of the intent of the user of the smartphone 302 that the door 214 of the meeting room 212 be unlocked. This may provide superior performance to an implementation that tries to achieve the same result (i.e., opening the door the user intends to open) using relative signal strength (e.g., Received Signal Strength Indicator (RSSI)) as measured by the smartphone 302 to infer user intent (e.g., relative RSSI of readers having an RSSI above a certain threshold for unlocking a door). The RSSI registered by the smartphone 302 with respect to various different readers may fluctuate for many reasons, which may lead to undesired results. Moreover, even when accurate, stronger RSSI (or proximity in general) is an imperfect proxy for the intent of a user with respect to a certain door they desire to unlock.

In addition to displaying the mobile ID 304, the example user interface 300 shows representations of three readers: a reader icon 306, a reader icon 308, and a reader icon 310. The reader icon 306 is shown with an associated lock icon 312 and blank heart icon 318, the reader icon 308 is shown with an associated lock icon 314 and blank heart icon 320, and the reader icon 310 is shown with an associated lock icon 316 and blank heart icon 322. Each reader icon may have a reader number, abbreviation, name, or the like displayed thereon to indicate which reader a given reader icon represents at a given moment. In some embodiments, the reader icons are displayed from left to right in decreasing order of RSSI.

Moreover, the associated lock icons may be tappable to cause the associated reader to unlock. Furthermore, in this example, the fact that all three of the heart icons are blank in FIG. 3 represents a state in which none of the three displayed readers has been designated as a favorite by the user. Indeed, the user may not have designated any readers as a favorite at that point.

FIG. 4 depicts a second example user interface 400, in accordance with at least one embodiment. A number of elements of FIG. 4 are also depicted in FIG. 3 and accordingly are not reintroduced here. This convention is followed throughout the ensuing figures. The difference in FIG. 4 as compared with FIG. 3 is that a tap 402 has been made on the reader icon 310, which causes the associated reader to unlock. It is noted that this is still in a context in which none of the displayed readers has been designated as a favorite. In accordance with the unlocking of the associated reader, a checkmark 404 at least temporarily replaces the lock icon that had been associated with that reader.

FIG. 5 depicts a third example user interface 500, in accordance with at least one embodiment. In contrast to the previous two figures, the example user interface 500 shows a reader icon 502 having an associated striped heart icon 506 instead of a blank heart icon, and similarly a reader icon 504 having an associated striped heart icon 508. This is an indication that a user has designated at least those two readers as being favorites. The user may do so by tapping on the heart icon, navigating through reader settings, or the like. It is noted that readers may also be deselected as favorites using, e.g., another tap of the associated heart icon, another configuration of one or more settings, and so on.

In some embodiments, one or more readers are programmatically (i.e., “intelligently”) designated as favorites. In some cases, this programmatic designation may take place based on historical usage data of the particular user, considering factors associated with previous times that the user unlocked a door via a given reader. Such factors may include day of the week, time of day, user's location, frequency of unlocking particular doors via particular readers, or the like. Certainly one or more other factors may be utilized instead of or in addition to one or more those the factors mentioned here. Moreover, in some embodiments, artificial intelligence (AI) (e.g., machine learning (ML)) may be used to select particular readers as favorites for particular users based on one or more of the factors mentioned in the present disclosure or one or more other factors deemed suitable by those of skill in the art for a given implementation or in a given context.

Returning now to the present example, the “CO” depicted on the reader icon 502 in this example indicates that that icon is associated with the reader 222 that secures the door 220 of the corner office 218. Similarly, the “LR” depicted on the reader icon 504 indicates that that icon is associated with the reader 254 that secures the door 252 of the lunchroom 250. Finally, the “MR” on the reader icon 310 indicates that that icon is associated with the (currently non-favorite) reader 216 that secures the door 214 of the meeting room 212.

In at least one embodiment, the favorite readers are displayed in a first list (or segment or area, etc., of the user interface) in descending order of current RSSI as measured by the smartphone 302, and one or more other non-favorite readers are displayed in a second list (or segment or area, etc., of the user interface) in descending order (within that category) of current RSSI. The descending order may include a ranking of the favorite readers, for example based on proximity (e.g., current RSSI), user preference (e.g., a user specified ranking of favorite readers), by most engaged reader historically (e.g., within a time period), or the like. A reader may be selected to engage with based on it being a highest ranked proximate reader (e.g., within a threshold distance), even if the highest ranked proximate reader is not the closest by proximity to the smartphone 302.

Thus, the user interface 500 may correspond to the smartphone 302 belonging to (or at least being used by, etc.) the occupant of the corner office 218 at a time when that person is standing near their office (and thus also somewhat near the meeting room 212). When the user indicates an intent to unlock a door (i.e., a user-interface command of some sort (e.g., a twist-&-go gesture) is received), the smartphone 302 may identify and list reader(s) that are nearby (e.g., proximate, such as within a threshold distance, which may include a user specified distance or a technical limitation distance such as a communication range over NFC or Bluetooth), indicate which if any of those are currently designated as a favorite, and identify which of the favorite readers (if there are any) is closest to the user. The smartphone 302 may then engage with that closest favorite reader. If there are no favorite readers in range (or designated at all), the smartphone 302 may engage with the closest (non-favorite) reader. The smartphone 302 may detect one or more proximate secure access readers, for example in response to a trigger action (e.g., a gesture, a proximity, a gate such as a digital gate, or the like). In some examples, the smartphone 302 may engage with a nearest reader, for example when there are no proximate secure access readers in a list of designated secure access readers (e.g., favorites).

In some embodiments, the associated app provides an activity log showing all recently performed transactions, state, time, or the like. Moreover, favorite-reader-enabled embodiments such as those described herein, which provide what is referred to herein at times as the favorite-reader feature, offer certain advantages, some of which are giving end users control over which readers to engage, preventing unintended or unwanted triggering of wrong readers, providing the capability to isolate specific readers in a multi-reader environment, and increasing the overall consistency and success rate of the door-opening experience for the end user.

FIG. 6 depicts a fourth example user interface 600, in accordance with at least one embodiment. The example user interface 600 of FIG. 6 is quite similar to the example user interface 500 of FIG. 5, other than a lightning-bolt icon 602 appearing on the reader icon 502. As described above, the “CO” on the reader icon 502 indicates that the reader icon 502 currently represents the reader 222 that secures the door 220 of the corner office 218.

The lightning-bolt icon 602 indicates that the user of the smartphone 302 is currently set up for what is referred to in the present disclosure as “seamless access” to the reader 222. According to seamless-access mode, the user may leave the phone in their pocket, bag, etc. and not touch it, and the credential automatically gets sent to the reader upon a determination being made of, e.g., the proximity of the user to the relevant reader and the motion vector of the user being directed sufficiently towards the relevant reader.

In at least one embodiment, seamless-access mode leverages range communication over BLE, as well as the herein-described favorite-reader feature, to provide seamless access to a given reader that the user indicates should be configured for them in such a way as to provide the seamless-access feature, which in at least one embodiment triggers an automatic door opening based on the user's relative distance to the particular reader (and in some cases the motion vector of the user as well). Among the benefits of the seamless-access feature are that users will be able to simply walk around their, e.g., office without worrying that they will seamlessly unlock doors that are not both (i) in their favorite list and (ii) marked enabled for seamless access.

Seamless access may include authenticating a user of the smartphone 302 before the smartphone 302 is within a threshold distance of a reader, for example after the reader is determined to be engaged with by the smartphone 302. In some examples, authenticating the user of the smartphone 302 includes automatically authenticating the user with the reader.

The reader may be identified (e.g., based on being specified in the example user interface 600) as a seamless reader.

FIG. 7 depicts a fifth example user interface 700, in accordance with at least one embodiment. In FIG. 7, the displayed reader icons include an entry-reader icon 702 and an exit-reader icon 704. In this example, both are associated with the above-described storage room 204. In particular, the entry-reader icon 702 is associated with the entry reader 208 (and marked by way of example with the word “IN”) whereas the exit-reader icon 704 is associated with the exit reader 210 (and marked by way of example with the word “OUT”).

In some embodiments, which are described herein as providing an entry-and-exit feature, users have the granularity option to designate one or more entry readers or one or more exit readers as favorites. Users also have the option to configure one or more entry readers or one or more exit readers for seamless access as described herein.

In the depicted example, the entry-reader icon 702 is associated with a striped heart icon 706, and the exit-reader icon 704 is associated with a striped heart icon 708, indicating that both the entry reader 208 and the exit reader 210 have been designated as favorites.

Moreover, it may be seen in FIG. 7 that a star icon 710 appears on the entry-reader icon 702. In this example, upon arriving to the office in the morning, the star icon 710 indicates that the entry reader 208 is currently favored over (i.e., is a little more of a favorite than) the exit reader 210. This makes sense because the user may not be in the storage room 204 immediately upon arrival at work that day.

FIG. 8 depicts a sixth example user interface 800, in accordance with at least one embodiment. Continuing the example scenario described just above, the user then proceeds to approach the storage room 204, at which point the entry reader 208 opens for the user (either by gesture or seamless access) but the exit reader 210 is not engaged at that time, because, as stated, the entry reader 208 is favored over the exit reader 210 at that time. In an embodiment, this favoritism is realized by including in the BLE messaging a unique identifier for the more-favorite reader. That identifier may be a Product Serial Number (PSN) of the given reader, among other options (such as MAC address or the like). Entry and exit readers may be configured to respond if their particular identifier is contained in the relevant messaging, and to not respond if that is not the case.

Once the user has gained access to and entered the storage room 204, the smartphone 302 may then display the user interface 800, which matches the user interface 700 of FIG. 7 other than that the star icon 710 has been switched to being displayed on the exit-reader icon 704, which is associated with the exit reader 210. Thus, the user entering the storage room 204 causes a toggle from the entry reader 208 being favored over the exit reader 210 to the exit reader 210 then being favored over the entry reader 208. Upon leaving the storage room 204, the toggle may switch back in preparation for the user to successfully reenter the storage room 204 at a later time that day or on a later day, as examples.

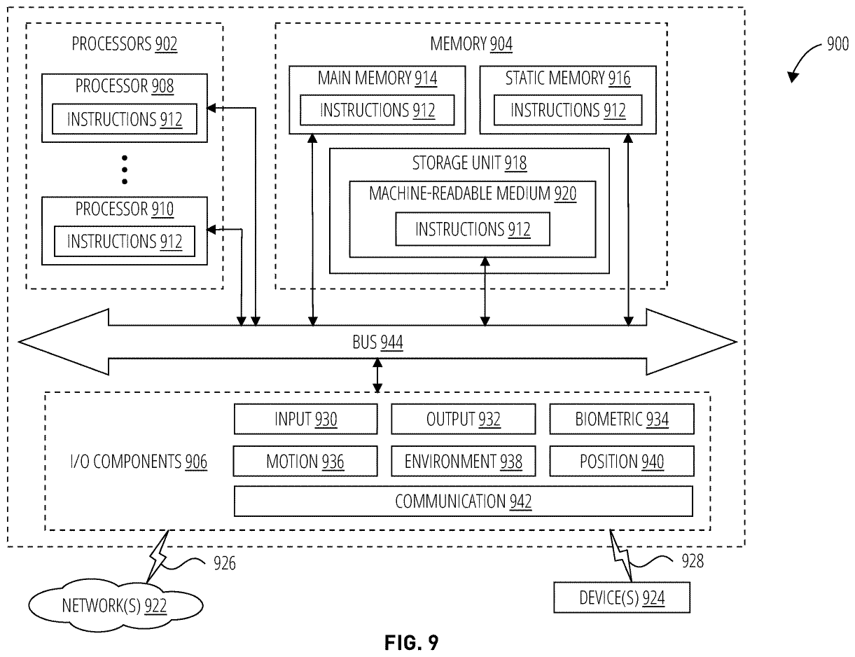

FIG. 9 depicts an example computer system 900 that may be utilized to embody or perform at least one embodiment, and within which instructions 912 (e.g., software, a program, an application, an applet, an app, or other executable code) may be executed to cause the computer system 900 to perform any one or more of the methodologies discussed herein. For example, execution of the instructions 912 may cause the computer system 900 to perform any one or more of the methods described herein. The instructions 912 transform the general, non-programmed computer system 900 into a particular computer system 900 programmed to carry out the described and illustrated functions in the manner described. The computer system 900 may operate as a standalone device or may be coupled (e.g., networked) to other machines. In a networked deployment, the computer system 900 may operate in the capacity of a server machine or a client machine in a server-client network environment, or as a peer machine in a peer-to-peer (or distributed) network environment.

The computer system 900 may be or include, but is limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any other machine capable of executing the instructions 912, sequentially or otherwise, that specify actions to be taken by the computer system 900. Further, while only a single computer system 900 is illustrated, the term “machine” shall also be taken to include a collection of machines that individually or jointly execute the instructions 912 to perform any one or more of the methodologies discussed herein.

The computer system 900 may include processors 902 (e.g., processing circuitry), memory 904, and I/O components 906, which may be configured to communicate with each other via a bus 944. In an example embodiment, the processors 902 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 908 and a processor 910 that execute the instructions 912. The term “processor” may include processing circuitry, may include multi-core processors that may include two or more independent processors (sometimes referred to as “cores”) that may execute instructions contemporaneously. Although FIG. 9 shows multiple processors 902, the computer system 900 may include a single processor with a single core, a single processor with multiple cores (e.g., a multi-core processor), multiple processors with a single core, multiple processors with multiples cores, or any combination thereof.

The memory 904 includes a main memory 914, a static memory 916, and a storage unit 918, each of which is accessible to the processors 902 via the bus 944. The memory 904, the static memory 916, or the storage unit 918 may store the instructions 912 executable for performing any one or more of the methodologies or functions described herein. The instructions 912 may also or instead reside completely or partially within the main memory 914, within the static memory 916, within machine-readable medium 920 within the storage unit 918, within at least one of the processors 902 (e.g., within a cache memory of a given one of the processors 902), or any suitable combination thereof, during execution thereof by the computer system 900. The machine-readable medium 920 is one or more non-transitory computer-readable storage media.

The I/O components 906 may include a wide variety of components to receive input, produce or provide output, transmit information, exchange information, capture measurements, or the like. The specific I/O components 906 that are included in a particular instance of the computer system 900 will depend on the type of machine. For example, portable machines such as mobile phones may include a touch input device or other such input mechanisms, while a headless server machine may not include such a touch input device. It will be appreciated that the I/O components 906 may include many other components that are not shown in FIG. 9.

In various example embodiments, the I/O components 906 may include output components 932 and input components 930. The output components 932 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touchscreen configured to receive alphanumeric input, a photo-optical keyboard, or other alphanumeric input components), point-based input components (e.g., a mouse, a touchpad, a trackball, a joystick, a motion sensor, or one or more other pointing instruments), tactile input components (e.g., a physical button, a touchscreen that is responsive to location or force of touches or touch gestures, or one or more other tactile input components), audio input components (e.g., a microphone), or the like.

In further example embodiments, the I/O components 906 may include biometric components 934, motion components 936, environmental components 938, or position components 940, among a wide array of other components. The biometric components 934 may include components to detect expressions (e.g., hand expressions, facial expressions, vocal expressions, body gestures, eye tracking, or the like), measure biosignals (e.g., blood pressure, heart rate, body temperature, perspiration, brain waves, or the like), identify a person (by way of, e.g., voice identification, retinal identification, facial identification, fingerprint identification, or electroencephalogram-based identification), or the like. The motion components 936 may include acceleration-sensing components (e.g., an accelerometer), gravitation-sensing components, rotation-sensing components (e.g., a gyroscope), etc.

The environmental components 938 may include, for example, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors that detect nearby objects), gas-sensing components (e.g., gas-detection sensors to detection concentrations of hazardous gases for safety or to measure pollutants in the atmosphere), or other components that may provide indications, measurements, signals, or the like that correspond to a surrounding physical environment.

The position components 940 may include location-sensing components (e.g., a global positioning system (GPS) receiver), altitude-sensing components (e.g., altimeters or barometers that detect air pressure from which altitude may be derived), orientation-sensing components (e.g., magnetometers), or the like.

Communication may be implemented using a wide variety of technologies. The I/O components 906 may further include communication components 942 operable to communicatively couple the computer system 900 to a network 922 or devices 924 via a coupling 926 or a coupling 928, respectively. For example, the communication components 942 may include a network-interface component or another suitable device to interface with the network 922. In further examples, the communication components 942 may include wired-communication components, wireless-communication components, cellular-communication components, Near Field Communication (NFC) components, Bluetooth (e.g., Bluetooth Low Energy) components, Wi-Fi components, or other communication components to provide communication via one or more other modalities. The devices 924 may include one or more other machines or any of a wide variety of peripheral devices (e.g., a peripheral device coupled via a universal serial bus (USB) connection).

Moreover, the communication components 942 may detect identifiers or include components operable to detect identifiers. For example, the communication components 942 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, or other optical codes), or acoustic-detection components (e.g., microphones to identify tagged audio signals). In addition, a variety of information may be derived via the communication components 942, such as location via Internet Protocol (IP) geolocation, location via Wi-Fi signal triangulation, location via detecting an NFC beacon signal that may indicate a particular location, or the like.

One or more of the various memories (e.g., the memory 904, the main memory 914, the static memory 916, or the (e.g., cache) memory of one or more of the processors 902) or the storage unit 918 may store one or more sets of instructions (e.g., software) or data structures embodying or used by any one or more of the methodologies or functions described herein. These instructions (e.g., the instructions 912), when executed by one or more of the processors 902, cause various operations to implement various embodiments of the present disclosure.

The instructions 912 may be transmitted or received over the network 922, using a transmission medium, via a network-interface device (e.g., a network-interface component included in the communication components 942) and using any one of a number of well-known transfer protocols (e.g., the Session Initiation Protocol (SIP), the hypertext transfer protocol (HTTP), or the like). Similarly, the instructions 912 may be transmitted or received using a transmission medium via the coupling 928 (e.g., a peer-to-peer coupling) to the devices 924.

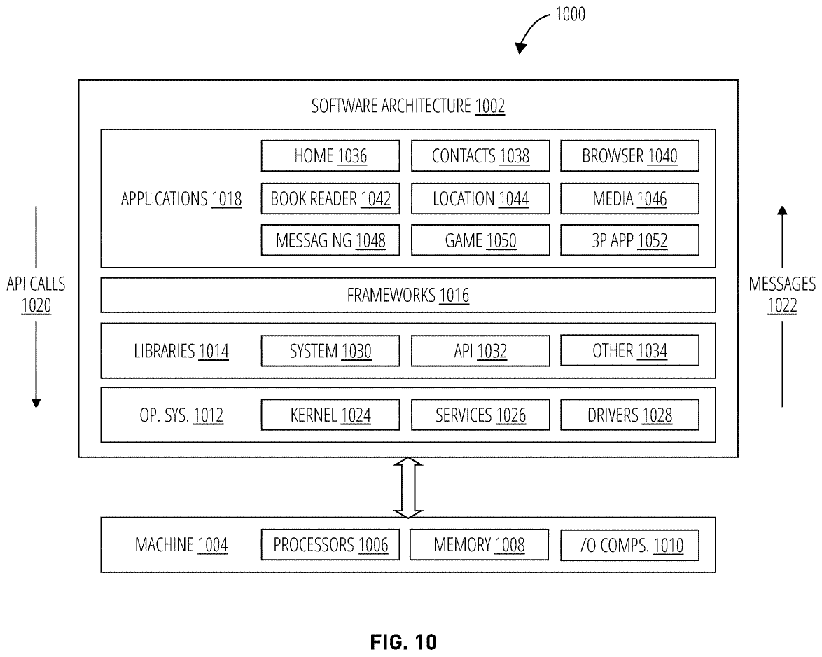

FIG. 10 depicts an example software architecture 1002 that may be executed on a computing device 1000, such as the example computer system 900 of FIG. 9, in accordance with at least one embodiment. The illustrated example software architecture 1002 may be installed on any one or more of the devices described herein. For example, the software architecture 1002 may be installed on any device or system that is arranged similar to the computer system 900 of FIG. 9. The software architecture 1002 is supported by hardware such as a machine 1004 that includes processors 1006, memory 1008, and I/O components 1010. In this example, the software architecture 1002 may be conceptualized as a stack of layers, where each layer provides a particular functionality. The software architecture 1002 includes layers such an operating system 1012, libraries 1014, frameworks 1016, and applications 1018. Operationally, using one or more application programming interfaces (APIs), the applications 1018 invoke API calls 1020 through the software stack and receive messages 1022 in response to the API calls 1020.

The operating system 1012 manages hardware resources and provides common services. The operating system 1012 includes, for example, a kernel 1024, services 1026, and drivers 1028. The kernel 1024 acts as an abstraction layer between the hardware and the other software layers. For example, the kernel 1024 may provide memory management, processor management (e.g., scheduling), component management, networking, or security settings, in some cases among other functionality. The services 1026 may provide other common services for the other software layers. The drivers 1028 are responsible for controlling or interfacing with the underlying hardware. For instance, the drivers 1028 may include display drivers, camera drivers, Bluetooth or Bluetooth Low Energy drivers, flash memory drivers, serial communication drivers (e.g., USB drivers), Wi-Fi drivers, audio drivers, power management drivers, or the like.

The libraries 1014 provide a low-level common infrastructure used by the applications 1018. The libraries 1014 may include system libraries 1030 (e.g., a C standard library) that provide functions such as memory-allocation functions, string-manipulation functions, mathematic functions, or the like. In addition, the libraries 1014 may include API libraries 1032 such as media libraries (e.g., libraries to support presentation or manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), Portable Network Graphics (PNG), or the like), graphics libraries (e.g., an OpenGL framework used to render in two dimensions (2D) and three dimensions (3D) in graphic content on a display), database libraries (e.g., SQLite to provide various relational-database functions), web libraries (e.g., WebKit to provide web-browsing functionality), or the like. The libraries 1014 may also include a wide variety of other libraries 1034 to provide many other APIs to the applications 1018.

The frameworks 1016 may provide a high-level common infrastructure that is used by the applications 1018. For example, the frameworks 1016 may provide various graphical user interface (GUI) functions, high-level resource management, high-level location services, or the like. The frameworks 1016 may provide a broad spectrum of other APIs that may be used by the applications 1018, some of which may be specific to a particular operating system or platform.

Purely as representative examples, the applications 1018 may include a home application 1036, a contacts application 1038, a browser application 1040, a book-reader application 1042, a location application 1044, a media application 1046, a messaging application 1048, a game application 1050, or a broad assortment of other applications generically represented in FIG. 10 as a third-party application 1052. The applications 1018 are programs that execute functions defined in the programs. Various programming languages may be employed to create one or more of the applications 1018, structured in a variety of manners, such as object-oriented programming languages (e.g., Objective-C, Java, C++, etc.), procedural programming languages (e.g., C, assembly language, etc.), or the like. In a specific example, the third-party application 1052 (e.g., an application developed using the ANDROID™ or IOST software development kit (SDK) by an entity other than the vendor of the particular platform) may be mobile software running on a mobile operating system such as IOST, ANDROID™, WINDOWS® Phone, or the like. In this example, the third-party application 1052 may invoke the API calls 1020 provided by the operating system 1012 to facilitate functionality described herein.

As described herein, one or more embodiments of the present disclosure take the form of methods that include multiple operations. One or more other embodiments take the form of systems that include at least one hardware processor and that also include one or more non-transitory computer-readable storage media containing instructions that, when executed by the at least one hardware processor, cause the at least one hardware processor to perform multiple operations (that in some embodiments do and in other embodiments do not correspond to operations performed in a herein-disclosed method embodiment). Still one or more other embodiments take the form of one or more non-transitory computer-readable storage media (CRM) containing instructions that, when executed by at least one hardware processor, cause the at least one hardware processor to perform multiple operations (that, similarly, in some embodiments do and in other embodiments do not correspond to operations performed in a herein-disclosed method embodiment or operations performed by a herein-disclosed system embodiment).

Furthermore, a number of variations and permutations of embodiments are described herein, and it is expressly noted that any variation or permutation that is described in this disclosure may be implemented with respect to any type of embodiment. For example, a variation or permutation that is primarily described in this disclosure in connection with a method embodiment may just as well or instead be implemented in connection with a system embodiment or a CRM embodiment. Furthermore, this flexibility and cross-applicability of embodiments is present in spite of any slightly different language (e.g., processes, methods, methodologies, steps, operations, functions, or the like) that is used to describe or characterize such embodiments or any element or elements thereof.

In this disclosure, in one or more embodiments, examples, or the like, it may be the case that one or more components of one or more devices, systems, or the like are referred to as modules that carry out (e.g., perform, execute, and the like) various functions. With respect to any such usages in the present disclosure, a module includes both hardware and instructions. The hardware may include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), or one or more devices or components of any other type deemed suitable by those of skill in the art for a given implementation.

In at least one embodiment, the instructions for a given module are executable by the hardware for carrying out the one or more herein-described functions of the module, and may include hardware (e.g., hardwired) instructions, firmware instructions, software instructions, or the like, stored in any one or more non-transitory computer-readable storage media deemed suitable by those of skill in the art for a given implementation. Each such non-transitory computer-readable storage medium may be or include memory (e.g., random access memory (RAM), read-only memory (ROM), erasable programmable read-only memory (EPROM), electrically erasable programmable read-only memory (EEPROM a.k.a. E2PROM), flash memory, or one or more other types of memory) or one or more other types of non-transitory computer-readable storage medium. A module may be realized as a single component or be distributed across multiple components. In some cases, a module may be referred to as a unit.

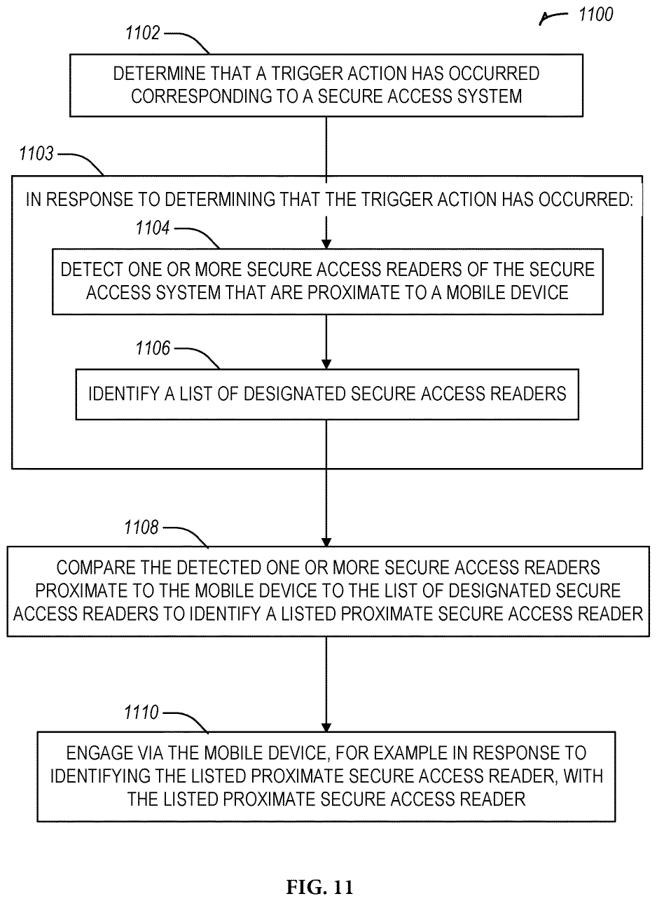

FIG. 11 depicts a flowchart showing a technique for selective engagement with a secure reader, in accordance with at least one embodiment. In an example, operations of the technique 1100 may be performed by processing circuitry, for example by executing instructions stored in memory, such as at a mobile device. The processing circuitry may include a processor, a system on a chip, or other circuitry (e.g., wiring). For example, technique 1100 may be performed by processing circuitry of a device (or one or more hardware or software components thereof), such as those illustrated and described with reference to FIGS. 9-10.

The technique 1100 includes an operation 1102 to determine, for example at a mobile device, that a trigger action has occurred corresponding to a secure access system. The trigger action may include at least one of a gesture, a user input on a user interface of the mobile device, an indication that the mobile device is within a threshold proximity of at least one secure access reader, a detected movement of the mobile device towards a secure access reader, or the like.

The technique 1100 includes an operation 1103, which includes operations 1104 and 1106. Operation 1103 includes performing operations 1104 and 1106 in response to determining that the trigger action of operation 1102 has occurred.

The technique 1100 includes an operation 1104 to in response to determining that the trigger action has occurred, detect one or more secure access readers of the secure access system that are proximate to the mobile device. Operation 1104 may include using a received signal strength indicator based on wireless communication between the mobile device and one or more proximate secure access readers.

The technique 1100 includes an operation 1106 to in response to determining that the trigger action has occurred, identify a list of designated secure access readers. The list of designated secure access readers may include a favorite list for a user. The favorite list may be generated based on a user interaction with a user interface on the mobile device, for example based on user selection of one or more favorite secure access readers. The favorite list may be generated based on user interactions with one or more secure access readers (e.g., automatically generating the favorite list based on one or more most frequently interacted with secure access devices). In some examples, both user selection and interaction with a secure access device may be used to generate a favorite list.

The technique 1100 includes an operation 1108 to compare the detected one or more secure access readers proximate to the mobile device to the list of designated secure access readers to identify a listed proximate secure access reader. The list of designated secure access readers may be ranked, in an example. In this example, the listed proximate secure access reader may include a highest ranked proximate secure access reader among secure access readers on the list of designated secure access readers. Operation 1108 may include identifying two listed proximate secure access readers. In this example, the listed proximate secure access reader may be identified as being nearer to the mobile device than another of the two listed proximate secure access readers.

The technique 1100 includes an operation 1110 to engage via the mobile device, for example in response to identifying the listed proximate secure access reader, with the listed proximate secure access reader. In an example, the listed proximate secure access reader is an entry reader paired with an exit reader. In this example, after operation 1110, the technique 1100 may include activating the exit reader on the list of proximate secure access readers and deactivating the listed proximate secure access reader. Operation 1110 may include authenticating a user of the mobile device before the mobile device is within a threshold distance of the listed proximate secure access reader. For example, the listed proximate secure access reader may be marked as a seamless reader in the list of designated secure access readers, and the user may be automatically authenticated with the seamless reader.

The technique 1100 may include an optional operation to receive or determine a second trigger action, and in response, determine that there are no proximate secure access readers in the list of designated secure access readers. In this example, the mobile device may engage with a nearest secure access reader.

Example 1 is a method comprising: determining, at a mobile device, that a trigger action has occurred corresponding to a secure access system; in response to determining that the trigger action has occurred: detecting one or more secure access readers of the secure access system that are proximate to the mobile device; and identifying a list of designated secure access readers; comparing the detected one or more secure access readers proximate to the mobile device to the list of designated secure access readers to identify a listed proximate secure access reader; and engaging via the mobile device, in response to identifying the listed proximate secure access reader, with the listed proximate secure access reader.

In Example 2, the subject matter of Example 1 includes, wherein the list of designated secure access readers is ranked, and wherein the listed proximate secure access reader is a highest ranked proximate secure access reader among secure access readers on the list of designated secure access readers.

In Example 3, the subject matter of Examples 1-2 includes, wherein the trigger action includes at least one of a gesture, a user input on a user interface of the mobile device, an indication that the mobile device is within a threshold proximity of at least one secure access reader, or a detected movement of the mobile device towards a secure access reader.

In Example 4, the subject matter of Examples 1-3 includes, receiving a second trigger action; in response, determining that there are no proximate secure access readers in the list of designated secure access readers; determining a nearest secure access reader not in the list of designated secure access readers; and engaging with the nearest secure access reader via the mobile device.

In Example 5, the subject matter of Examples 1-4 includes, wherein comparing the detected one or more secure access readers proximate to the mobile device to the list of designated secure access readers includes identifying two listed proximate secure access readers, and wherein the listed proximate secure access reader is nearer to the mobile device than another of the two listed proximate secure access readers.

In Example 6, the subject matter of Examples 1-5 includes, wherein the listed proximate secure access reader is an entry reader paired with an exit reader, and further comprising, after engaging with the listed proximate secure access reader, activating the exit reader on the list of proximate secure access readers and deactivating the listed proximate secure access reader.

In Example 7, the subject matter of Examples 1-6 includes, wherein detecting the one or more secure access readers of the secure access system that are proximate to the mobile device includes using a received signal strength indicator based on wireless communication between the mobile device and one or more proximate secure access readers.

In Example 8, the subject matter of Examples 1-7 includes, wherein engaging with the listed proximate secure access reader via the mobile device includes authenticating a user of the mobile device before the mobile device is within a threshold distance of the listed proximate secure access reader.

In Example 9, the subject matter of Example 8 includes, wherein the listed proximate secure access reader is marked as a seamless reader in the list of designated secure access readers, and wherein authenticating the user of the mobile device includes automatically authenticating the user with the seamless reader.

In Example 10, the subject matter of Examples 1-9 includes, wherein the list of designated secure access readers includes a favorite list of a user generated based on a user interaction with a user interface on the mobile device.

Example 11 is at least one machine readable medium of a mobile device, including instructions, which when executed by processing circuitry, cause the processing circuitry to perform operations to: determine that a trigger action has occurred corresponding to a secure access system; in response to determining that the trigger action has occurred: detect one or more secure access readers of the secure access system that are proximate to the mobile device; and identify a list of designated secure access readers; compare the detected one or more secure access readers proximate to the mobile device to the list of designated secure access readers to identify a listed proximate secure access reader; and engage via the mobile device, in response to identifying the listed proximate secure access reader, with the listed proximate secure access reader.

In Example 12, the subject matter of Example 11 includes, wherein the list of designated secure access readers is ranked, and wherein the listed proximate secure access reader is a highest ranked proximate secure access reader among secure access readers on the list of designated secure access readers.

In Example 13, the subject matter of Examples 11-12 includes, wherein the trigger action includes at least one of a gesture, a user input on a user interface of the mobile device, an indication that the mobile device is within a threshold proximity of at least one secure access reader, or a detected movement of the mobile device towards a secure access reader.

In Example 14, the subject matter of Examples 11-13 includes, wherein the listed proximate secure access reader is an entry reader paired with an exit reader, and wherein the instructions further include, after engaging with the listed proximate secure access reader, operations to cause the exit reader on the list of proximate secure access readers and deactivate the listed proximate secure access reader.

In Example 15, the subject matter of Examples 11-14 includes, wherein to engage with the listed proximate secure access reader via the mobile device, the instructions further include operations to authenticate a user of the mobile device before the mobile device is within a threshold distance of the listed proximate secure access reader.

In Example 16, the subject matter of Example 15 includes, wherein the listed proximate secure access reader is marked as a seamless reader in the list of designated secure access readers, and wherein to authenticate the user of the mobile device, the instructions further include operations to automatically authenticate the user with the seamless reader.

In Example 17, the subject matter of Examples 11-16 includes, wherein the list of designated secure access readers includes a favorite list of a user generated based on a user interaction with a user interface on the mobile device.

Example 18 is a mobile device comprising: processing circuitry; and memory, including instructions, which when executed by the processing circuitry, cause the processing circuitry to perform operations to: determine that a trigger action has occurred corresponding to a secure access system; in response to determining that the trigger action has occurred: detect one or more secure access readers of the secure access system that are proximate to the mobile device; and identify a list of designated secure access readers; compare the detected one or more secure access readers proximate to the mobile device to the list of designated secure access readers to identify a listed proximate secure access reader; and engage via the mobile device, in response to identifying the listed proximate secure access reader, with the listed proximate secure access reader.

In Example 19, the subject matter of Example 18 includes, wherein the list of designated secure access readers is ranked, and wherein the listed proximate secure access reader is a highest ranked proximate secure access reader among secure access readers on the list of designated secure access readers.

In Example 20, the subject matter of Examples 18-19 includes, wherein the trigger action includes at least one of a gesture, a user input on a user interface of the mobile device, an indication that the mobile device is within a threshold proximity of at least one secure access reader, or a detected movement of the mobile device towards a secure access reader.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that may therefore be read in isolation and out of context as absolute and thus as a limitation on all embodiments, may only properly be read as being constructively qualified by such a clause. It is for reasons akin to brevity and clarity of presentation that this implied qualifying clause is not repeated ad nauseum in this disclosure.

1. A method comprising:
determining, at a mobile device, that a trigger action has occurred corresponding to a secure access system;
in response to determining that the trigger action has occurred:
detecting one or more secure access readers of the secure access system that are proximate to the mobile device; and
identifying a list of designated secure access readers, the list being generated based on a combination of proximity of the designated secure access readers and at least one of a reader type, a user selection, or a past interaction;
comparing the detected one or more secure access readers proximate to the mobile device to the list of designated secure access readers to identify a listed proximate secure access reader; and
engaging via the mobile device, in response to identifying the listed proximate secure access reader, with the listed proximate secure access reader.

2. The method of claim 1, wherein the list of designated secure access readers is ranked, and wherein the listed proximate secure access reader is a highest ranked proximate secure access reader among secure access readers on the list of designated secure access readers.

3. The method of claim 1, wherein the trigger action includes at least one of a gesture, a user input on a user interface of the mobile device, an indication that the mobile device is within a threshold proximity of at least one secure access reader, or a detected movement of the mobile device towards a secure access reader.

4. The method of claim 1, further comprising:
receiving a second trigger action;
in response, determining that there are no proximate secure access readers in the list of designated secure access readers;
determining a nearest secure access reader not in the list of designated secure access readers; and
engaging with the nearest secure access reader via the mobile device.

5. The method of claim 1, wherein comparing the detected one or more secure access readers proximate to the mobile device to the list of designated secure access readers includes identifying two listed proximate secure access readers, and wherein the listed proximate secure access reader is nearer to the mobile device than another of the two listed proximate secure access readers.

6. The method of claim 1, wherein the listed proximate secure access reader is an entry reader paired with an exit reader, and further comprising, after engaging with the listed proximate secure access reader, activating the exit reader on the list of proximate secure access readers and deactivating the listed proximate secure access reader.

7. The method of claim 1, wherein detecting the one or more secure access readers of the secure access system that are proximate to the mobile device includes using a received signal strength indicator based on wireless communication between the mobile device and one or more proximate secure access readers.

8. The method of claim 1, wherein engaging with the listed proximate secure access reader via the mobile device includes authenticating a user of the mobile device before the mobile device is within a threshold distance of the listed proximate secure access reader.

9. The method of claim 8, wherein the listed proximate secure access reader is marked as a seamless reader in the list of designated secure access readers, and wherein authenticating the user of the mobile device includes automatically authenticating the user with the seamless reader.

10. The method of claim 1, wherein the list of designated secure access readers includes a favorite list of a user generated based on a user interaction with a user interface on the mobile device.

11. At least one machine readable medium of a mobile device, including instructions, which when executed by processing circuitry, cause the processing circuitry to perform operations to:
determine that a trigger action has occurred corresponding to a secure access system;
in response to determining that the trigger action has occurred:
detect one or more secure access readers of the secure access system that are proximate to the mobile device; and
identify a list of designated secure access readers, the list being generated based on a combination of proximity of the designated secure access readers and at least one of a reader type, a user selection, or a past interaction;
compare the detected one or more secure access readers proximate to the mobile device to the list of designated secure access readers to identify a listed proximate secure access reader; and
engage via the mobile device, in response to identifying the listed proximate secure access reader, with the listed proximate secure access reader.

12. The at least one machine readable medium of claim 11, wherein the list of designated secure access readers is ranked, and wherein the listed proximate secure access reader is a highest ranked proximate secure access reader among secure access readers on the list of designated secure access readers.

13. The at least one machine readable medium of claim 11, wherein the trigger action includes at least one of a gesture, a user input on a user interface of the mobile device, an indication that the mobile device is within a threshold proximity of at least one secure access reader, or a detected movement of the mobile device towards a secure access reader.

14. The at least one machine readable medium of claim 11, wherein the listed proximate secure access reader is an entry reader paired with an exit reader, and wherein the instructions further include, after engaging with the listed proximate secure access reader, operations to cause the exit reader on the list of proximate secure access readers and deactivate the listed proximate secure access reader.

15. The at least one machine readable medium of claim 11, wherein to engage with the listed proximate secure access reader via the mobile device, the instructions further include operations to authenticate a user of the mobile device before the mobile device is within a threshold distance of the listed proximate secure access reader.

16. The at least one machine readable medium of claim 15, wherein the listed proximate secure access reader is marked as a seamless reader in the list of designated secure access readers, and wherein to authenticate the user of the mobile device, the instructions further include operations to automatically authenticate the user with the seamless reader.

17. The at least one machine readable medium of claim 11, wherein the list of designated secure access readers includes a favorite list of a user generated based on a user interaction with a user interface on the mobile device.

18. A mobile device comprising:
processing circuitry; and
memory, including instructions, which when executed by the processing circuitry, cause the processing circuitry to perform operations to:
determine that a trigger action has occurred corresponding to a secure access system;
in response to determining that the trigger action has occurred:
detect one or more secure access readers of the secure access system that are proximate to the mobile device; and
identify a list of designated secure access readers, the list being generated based on a combination of proximity of the designated secure access readers and at least one of a reader type, a user selection, or a past interaction;
compare the detected one or more secure access readers proximate to the mobile device to the list of designated secure access readers to identify a listed proximate secure access reader; and
engage via the mobile device, in response to identifying the listed proximate secure access reader, with the listed proximate secure access reader.

19. The mobile device of claim 18, wherein the list of designated secure access readers is ranked, and wherein the listed proximate secure access reader is a highest ranked proximate secure access reader among secure access readers on the list of designated secure access readers.

20. The mobile device of claim 18, wherein the trigger action includes at least one of a gesture, a user input on a user interface of the mobile device, an indication that the mobile device is within a threshold proximity of at least one secure access reader, or a detected movement of the mobile device towards a secure access reader.
